(19) United States
(12) Patent Application Publication
(10) Pub. No.: US 2022/0209903 A1
(43) Pub. Date: Jun. 30, 2022

(54) METHODS AND APPARATUS TO DELIVER RELIABLE MULTICAST SERVICES VIA PDCP RETRANSMISSION

(71) Applicant: MediaTek Singapore Pte. Ltd., Singapore (SG)

(72) Inventors: Yuanyuan Zhang, Beijing (CN); Xuelong Wang, Beijing (CN)

(21) Appl. No.: 17/568,666

(22) Filed: Jan. 4, 2022

Related U.S. Application Data
(63) Continuation of application No. PCT/CN2020/141399, filed on Dec. 30, 2020.

(30) Foreign Application Priority Data
Dec. 20, 2021 (CN) 202111561936.8

(51) Int. Cl. H04L 1/18; H04W 4/06; H04W 28/02; H04W 28/04

(52) U.S. Cl. CPC H04L 1/1835; H04W 4/06; H04W 80/02; H04W 28/0278; H04W 28/04; H04L 1/1848

(57) ABSTRACT

Apparatus and methods are provided for the UE-initiated PDCP status report for PDCP retransmission. In one novel aspect, the UE initiates a PDCP status report upon detecting SN gap in the PDCP SDU reception buffer for a period of time, which is controlled by a UE local t-reordering timer. The UE-initiated status report procedure performs an SN gap monitoring to compile a PDCP status report with updated SN gap information and sends the PDCP status report to the wireless network. In one embodiment, the t-reordering timer is started upon detecting the initial SN gap when there is no t-reordering timer running and is stopped upon detecting the SN gap being closed. In one embodiment, the PDCP status report is sent to the network upon detecting the t-reordering timer expires. In one embodiment, the PDCP status report includes a first missing count field and a bitmap for the missing SDUs.

### CROSS REFERENCE TO RELATED APPLICATIONS

This application is filed under 35 U.S.C. § 111 (a) and is based on and hereby claims priority under 35 U.S.C. § 120 and § 365 (c) from International Application No. PCT/CN2020/141399, titled “Methods and apparatus to Deliver Reliable Multicast Services via PDCP Retransmission,” with an international filing date of Dec. 30, 2020. This application claims priority under 35 U.S.C. § 119 from Chinese Application Number CN202111561936.8 titled “Methods and apparatus for PDCP status report procedure” filed on Dec. 20, 2021. The disclosure of: each of: the foregoing documents is incorporated herein by reference.

### TECHNICAL FIELD

The disclosed embodiments relate generally to wireless communication, and, more particularly, to PDCP STATUS REPORT PROCEDURE.

### BACKGROUND

With the exponential growth of wireless data services, the content delivery to large mobile user groups has grown rapidly. Initial wireless multicast/broadcast services include streaming services such as mobile TV and IPTV. With the growing demand for large group content delivery, recent application development for mobile multicast services requires highly robust and critical communication services such as group communication in disaster situations and the necessity of public safety network-related multicast services. The early 3GPP in the LIE standard defines enhanced multimedia broadcast. multicast services (eMBMS). The single-cell point to multipoint (SC-PTM) services and multicast-broadcast single-frequency network (MBSFN) are defined. The fifth generation (5G) multicast and broadcast services (PBS) are defined based on the unicast 5G core (5GC) architecture. A variety of applications may rely on communication over multicast transmission, such as live stream, video distribution, vehicle-to-everything (V2X) communication, public safety (PS) communication, file download, and so on. In some cases, there may be a need for the cellular system to enable reliable multicast transmission to ensure the reception quality at the UE side. Reliable transmission for some multicast services in the PR system requires feedback on the reception of the multicast transmission, which helps the network to perform necessary retransmission. of the content to the UE. A particular radio bearer (RB) should be introduced to deliver the multicast services to UE.

Improvements and enhancements are required to support PDCP status report procedure.

### SUMMARY

Apparatus and methods are provided for the UK-initiated PDCP status report for PDCP retransmission. In one novel aspect, the UE initiates a PDCP status report. The PDCP status report is initiated by the UE upon detecting SN gap in the PDCP SDU reception buffer for a period of time. In one embodiment, the time is controlled by a UE local t-reordering timer. The UK receives the PDCP PDU, stores PDCP SDU of the received PDCP PDU in a PDCP reception buffer, wherein a latest received PDCP SDU has a sequence number (SN) being (RX_NEXT-1), triggers a UE-initiated status report procedure upon detecting an initial SN gap eased on one or more stored SOUS, wherein the UE-initiated status report procedure performs an SN gap monitoring to compile a PDCP status report, and sends the PDCP status report to the wireless network upon detecting one or more predefined triggering events, wherein the PDCP status report comprises information of an updated SN gap generated. In one embodiment, the PDCP packets are for MES received from MRB. In another embodiment, the MRB is associated with a multicast channel to receive MBS data packets and a unicast channel to send feedback and to receive data retransmission, and wherein the status report is sent to the wireless network through the associated unicast channel. In one embodiment, the stored SDUs with consecutive SNs are delivered to upper layers with a delivered count RX_DELIV set to be a latest delivered SN, and wherein the initial SN gap is detected upon detecting RX_NEXT-1) is greater than RX_DELIV. A counter of RX_REORD is set to be RX_NEXT upon detecting the initial SN gap and is reset to be RX_NEXT upon sending the PDCP status report. The RX_REORD is reset upon detecting the SN gap being closed in one embodiment, the t-reordering timer is started upon detecting the initial SN gap when there is no t-reordering timer running and is stopped upon detecting the SN gap being closed. In one embodiment, the PDCP status report is sent to the network when the t-reordering timer expires. In one embodiment, the PDCP status report includes a first missing count field and a bitmap for the missing SDUs.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports PDCP status report procedure.

FIG. 2 illustrates an exemplary NR wireless system with centralized upper layers of: the NP radio interface stacks.

FIG. 3 illustrates exemplary diagrams for top level PDC? status report flow diagram and MBB configurations to support the reliable MBS.

FIG. 4 illustrates an exemplary protocol stack for a MRB configuration with PDCP-based retransmission.

FIG. 5 illustrates exemplary diagrams for the conditions and procedures for the UE-initiated PDCP status report.

FIG. 6 illustrates exemplary diagrams of conditions for the PDCP status reports.

FIG. 7 illustrates exemplary diagrams for an exemplary process to update the state variables and trigger a PDCP status report under the control of t-Reordering

FIG. 8 illustrates an exemplary flow chart for the UE-initiated PDCP status report procedure.

### DETAILED DESCRIPTION

Reference Will now be made in detail to some embodiments of the invention, examples of which are illustrated in the accompanying drawings.

Aspects of the present disclosure provide methods, apparatus, processing systems, and computer readable mediums for NR (new radio access technology, or 50 technology) or other radio access technologies. NR may support various wireless communication services, such as enhanced mobile broadband targeting wide bandwidth, millimeter wave targeting high carrier frequency, massive machine type communications targeting non-backward compatible MID techniques, and/or mission critical targeting ultra-reliable law-latency communications. These services may include latency and reliability requirements. These services may also have different transmission time intervals (TTI) to meet respective quality of service (QoS) requirements. In addition, these services may co-exist in the same subframe.

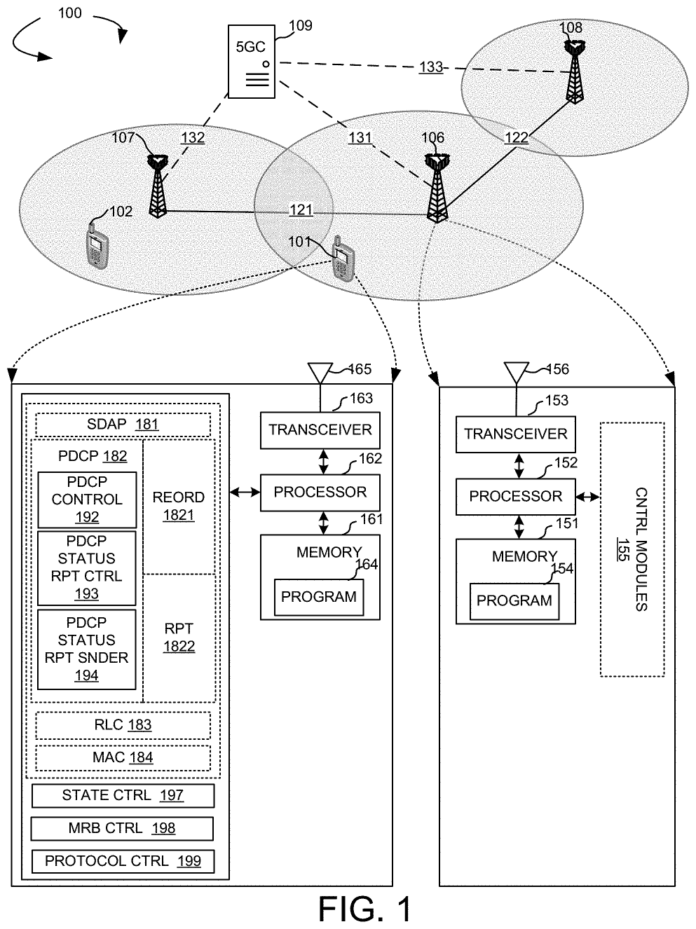

FIG. 1 is a schematic system diagram illustrating an exemplary wireless communication network that supports PDCP status report procedure. Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks gNB 106, qNB 107 and qNB 108 are base stations in the wireless network, the serving area of which may or may not overlap with each other. As an example, user equipment (UF) 101 or mobile station 101 is in the serving area covered by gNB 106 and gNB 107. As an example, UE 101 or mobile station 101 is only in the service area of gNB 106 and connected with gNB 106. UE 102 or mobile station 102 is only in the service area of gNB 107 and connected with gNB 107. gNB 106 is connected with gNB 107 via Xn interface 121. gNB 106 is connected with gNB 108 via Xn interface 122. A 5G network entity 109 connects with gNB 106, 107, and 108 via NC connection 131, 132, and L33, respectively. In one embodiment, gNB 106 and gNB 107 provide the same MEMO services. The service continuity during handover is guaranteed when UE 101 moves from gNB 106 to gNB 107 and vice versa. The area covered by gNB 106 and 107 with the same MEMS services is a multi cast service area for the MEMS services

FIG. 1 further illustrates simplified block diagrams of a base station and a mobile device/UE for multicast transmission. gNB 106 has an antenna 156, which transmits and receives radio signals. An RE transceiver circuit 153, coupled with the antenna 156, receives RE signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 106. Memory 151 stores program instructions and data 154 to control the operations of gNB 106. gNB 106 also includes a set of control modules 155 that carry out functional tasks to communicate with mobile stations. These control modules can be implemented by circuits, software, firmware, or a combination of them.

FIG. 1 also includes simplified block diagrams of a UE, such as UE 101. The UE has an antenna 165, which transmits and receives radio signals. An RE transceiver circuit 163, coupled with the antenna, receives RF signals from antenna 165, converts them to baseband signals, and sends them to processor 162. In one embodiment, the RE transceiver 163 may comprise two RF modules (not shown) which are used for different frequency bands transmitting and receiving. PE transceiver 163 also converts received baseband signals from processor 162, converts them to RF signals, and sends out to antenna 165. Processor 162 processes the received baseband signals and invokes different functional modules to perform features in UP 101. Memory 161 stores program instructions and data 164 to control the operations of UP 101. Antenna 165 sends uplink transmission and receives downlink transmissions to/from antenna 156 of gNB 106.

The UE also includes a set of: control modules that carry out functional tasks. These control modules can be implemented by circuits, software, firmware, or a combination of them. In one embodiment, the UE further has an RRC state controller 197, an MBS controller 198 and a protocol stack controller 199. RRO state controller 197 controls UE PRO state according to commands from the network and UE conditions. RRO supports the following states, RRC_IDLE, RRC_CONNECTED and RRC_INACTIVE. In one embodiment, UE can receive the multicast and broadcast services in RRC_IDLE/INACTIVE state. The UE applies the MRB establishment procedure to start receiving a session of a service it has an interest in. The UE applies the MRB release procedure to stop receiving a session, MBS controller 198 controls to establish/add, reconfigure/modify and release/remove a MPS based on different sets of conditions for MRS establishment, reconfiguration, and release. A protocol stack controller 199 manages to add, modify, or remove the protocol stack for the MRB.

The protocol Stack includes the packet data convergence protocol (PDCP) layer 182, the radio link. control (RLC) 183, the MAC layer 184 and the PHY layer (not shown). The PDCP layer (PDCP entity) 182 receives a PDCP data packet data unit (PDU) from a lower layer. In one embodiment, the PDCP layer supports reordering functions 1821 of transfer of data, maintenance of PDCP SN, header compression and decompression using the ROHC protocol, ciphering and deciphering, integrity protection and integrity verification, timer based SDU discard, routing for split bearer, duplication, re-ordering and in-order delivery, out of order delivery and duplication discarding. In one embodiment, the receiving PDCP entity, supporting PDCP status report function 1822, sends PDCP status report upon t-Reordering expiry. In one embodiment, the PDCP status reports triggers PDCP retransmission at the peer transmitting PDCP entity at the network side. A PDC? control module 192 stores a PDCP service data unit (SDU) of the received PDCP PDU in a PDCP reception buffer, wherein a latest received PDCP SDU has a sequence number (SN) and a hyper frame number (HFN). The count value for the latest received PDCP SDC RCVD_COUNT=[RCVD_HFN, RCVD_SN]. A PDCP status report control module 193 triggers a UE-initiated status report procedure upon detecting an initial SN gap based on one or more stored SDUs, wherein the UE-initiated status report procedure performs an SN gap monitoring to compile a PDCP status report. A PDCP status report sender 194 sends the PDCP status report to the wireless network upon detecting one or more predefined triggering events, wherein the PDCP status report comprises information of an updated SN gap generated.

In one embodiment, the service data adaptation protocol (SDAP) layer 181 is optionally configured. In one embodiment, the RLC layer 183 supports the functions of error correction through ARQ, segmentation and reassembly, re-segmentation, duplication detection, re-establishment, etc. In one embodiment, a new procedure for RLC reconfiguration is performed, which can reconfigure the PLC entity to associated to one or two logical channels. In another embodiment, the MAC layer 184 supports mapping between logical channels and transport channels, multiplexing, demultiplexing, HARQ, radio resource selection, and etc.

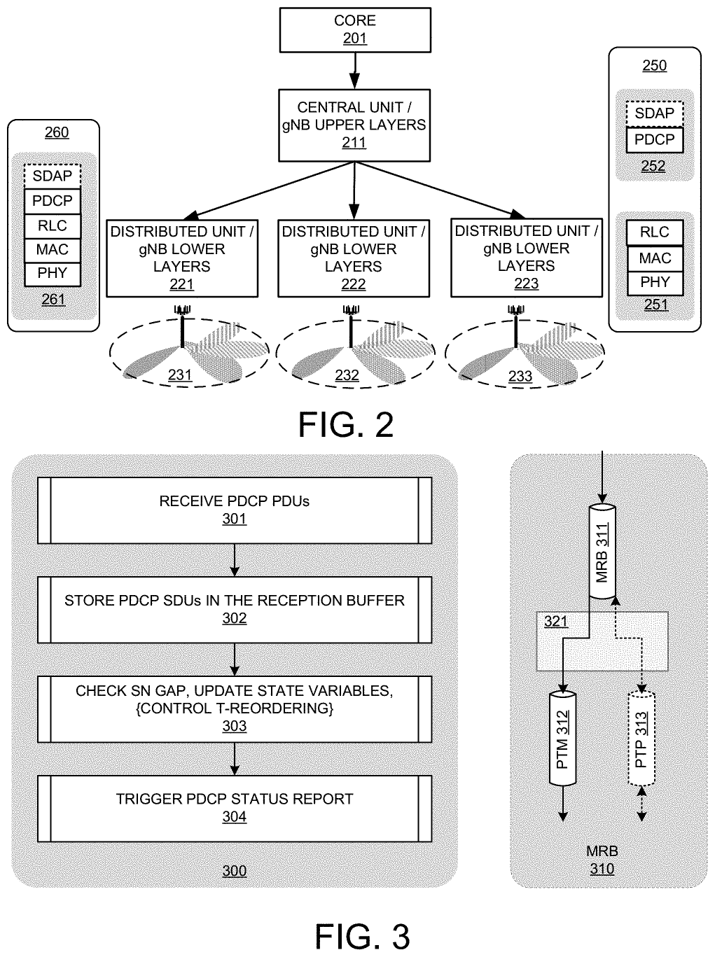

FIG. 2 illustrates an exemplary NR wireless system with centralized upper layers of the NR radio interface stacks. Different protocol spit options between central unit (CU) and distributed unit (DU) of gNB nodes may be possible. The functional spit between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization, and jitter. In one embodiment, SDAP and PDCP layer are located in the CU, while RLC, MAC and PHY layers are located in the DU. A core unit 201 is connected with one central unit 211 with qNB upper layer 252. In one embodiment 250, qNB upper layer 252 includes the PDCP layer and optionally the SDAP layer. Central unit 211 connects with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the PLC layers. In another embodiment 260, each gNB has the protocol stacks 261 including SDAP, PDCP, RLC, MAC and PHY layers.

FIG. 3 illustrates exemplary diagrams for top level PDCP status report flow diagram 300 and NAB configurations to support the reliable MBS. In one novel aspect, the UE monitors the sequence number (SN) of the PDCP service data unit. (SDU) and triggers a UE-initiated PDCP status report. At step 301, the UE receives PDCP PDUs from lower layers. At step 302, the UE stores the PDCP SDUs in the reception buffer. At step 303, the CE checks SN gap, update state variables based on the received data packets. In one embodiment, upon detecting the SN gap, a t-reordering timer is started to monitor whether the SN gap is closed. At step 304, the UE triggers the UE-initiated PDCP status report upon detecting one or more predefined triggering events.

In one embodiment, the UE-initiated PDCP status report is used for MBS. In certain systems, such as NR systems, NR multicast/broadcast is transmitted in the coverage of a cell. In one embodiment, multicast control channel (MCCH) provides the information of a list of NR multicast/broadcast services with ongoing sessions transmitted on multicast traffic channels (MTCHs). At physical layer, MTCH is scheduled by gNB in the search space of physical downlink control channel (PDCCH) with group radio network temporary identification (G-RNIT) scrambled. UE decodes the MTCH data for a multicast session in the multicast PDSCH. Multicast radio bearer provides multicast service, which is carried by multicast traffic channel (MTCH) only with a UE protocol stack, dedicated traffic channel (DTCH) only with a UE protocol stack, or both MTCH and DICE with a UE protocol stack 321. In one embodiment 310, the MRB 311 is configured to be associated to a MTCH and a DTCH. One or multiple multicast MPBs are established corresponding to the multicast flows of a particular multicast session in order to support the multicast transmission in the downlink over the air. The multicast Radio Bearer (i.e., MRB) can be subject to PTM transmission and PTP transmission or combination of PTM and PIP transmission within a cell. The different configuration can be described as different transmission modes/channels/MRB types in one embodiment 310 with split MRB configuration, the MRB 311 is configured in point-to-multipoint (PTM) leg 312 & point-to-point (PTP) leg 313.

In legacy systems supporting MBMS/eMBMS, the radio bearer structure for multicast and broadcast transmission is modelled in an independent way from unicast transmission. Because of the unidirectional transmission for legacy MBMS/eMBMS service, RLC unacknowledged mode (UM) is used for the transmission of multicast/broadcast session in this case there is no need to make the interaction between multicast and unicast for a particular UE which is in RRC Connected state. For the NR network, with new services provided through MBS, reliable transmission is required. The traditional multicast transmission does not ensure successful reception for all UEs, unless very conservative link adaptations are implemented, which greatly degrades the resource efficiency. To support reliable multicast transmission for PBS, a feedback channel in the uplink is needed for each UL receiving the service, which can be used by the receiving UK to feedback its reception status about the service to the network. Based on the feedback, the network may perform necessary retransmission to improve the transmission reliability. From uplink feedback perspective, the feedback channel may be used for L2 feedback, such as the RLC Status Report and/or the PDCP Status Report. Further, the feedback channel may be used for HARQ feedback. Furthermore, the feedback should be a bidirectional channel between the OF and the network, with the assumption that the network may take that channel to perform needed packet retransmission. The packet retransmission is L2 retransmission (e.g., RLC retransmission and/or PDCP retransmission). In addition, the feedback channel may be used for HARQ retransmission.

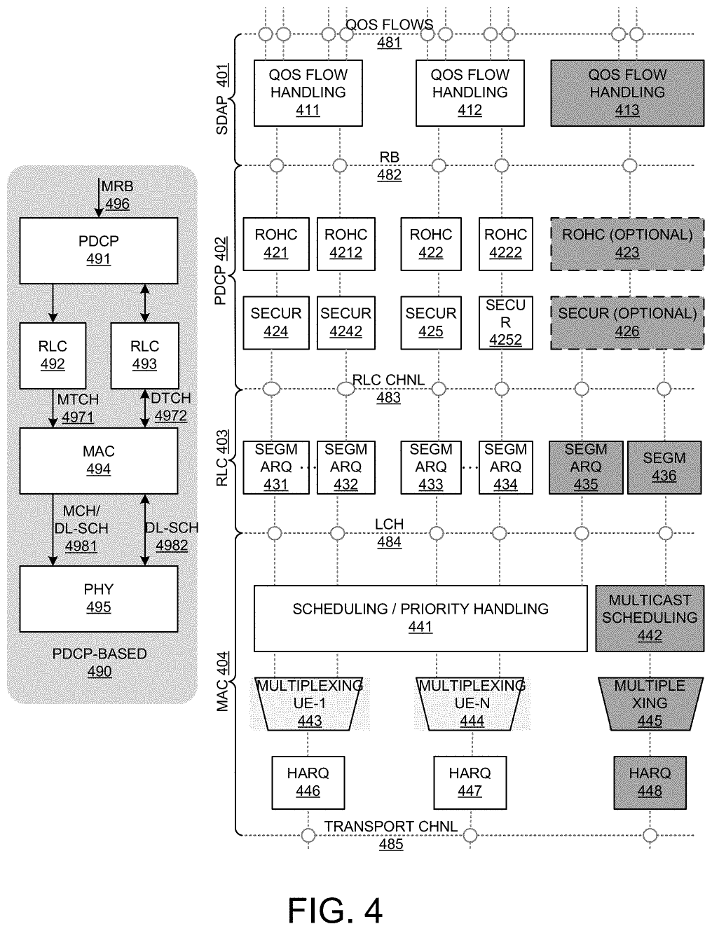

FIG. 4 illustrates an exemplary protocol stack for a MRB configuration with PDCP-based retransmission. In the PDCP-based retransmission 490, there is one PDCP entity 491 per MRB 496. Two logical channels, i.e., MTCH and DTCH are associated to the PDCP entity. Each logical channel is corresponding to a RLC entity, RLC 492 corresponding to the MTCH 4971 and RLC 493 corresponding to the DTCH 4972. From UE aspect, the PDCP status report to trigger PDCP retransmission is delivered to the RLC entity. 493 corresponding to DTCH. From network aspect, the PDCP protocol data units (PDUs) subject to retransmission are delivered through DTCH. The MAC entity maps the logical channel MTCH to the transport channel-1 4981 (e.g., MCH, DL-SCH) and maps the logical channel DTCH to the transport channe1-2 4982 (e.g., MOH, DL-SCH). OF monitors two independent transport channels via different radio network temporary identifiers (RNTIs). The ROHC function and security function is optional for multicast transmission. The PLC layer includes only segmentation and the ARQ function of RLC layer is moved to PDCP layer. RLC 492 and RLC 493 maps to MAC 494 and send the data packets to PHY 495.

A network entity, such as a base station/gNB, transmits MBS data packets with PTM link to a number N of UEs and retransmits PBS data packets based on feedbacks through associated PIP link with the PDCP-based protocol stack. An exemplary UE, correspondingly configured with PDCP-based protocol stack receives PBS data packets on the PTM RB from the bases station and sends feedback to the base station. The multicast is scheduled independently from PIP transmission. The protocol stack for both the base station and the UE includes SOAP layer 401, PDCP layer 402, RLC layer 403, and MAC layer 404. SOAP layer 401 handles QoS flows 481, including functions at the base station of QoS flow handling 411 for UE-1 and QoS flow handling 412 for UE-N, and functions at the UE of QoS flow handling 413 for the UE. The PDCP layer 402 includes ROHC functions and security functions. The ROHC function and security function is optional for multicast transmission. PDCP layer 402 includes base station functions of ROHC 421 and security 424 for UE-1 multicast, ROHC 4212 and security 4242 for UE-1 unicast, ROHC 422 and security 425 for UE-N multicast, ROHC 4222 and security 4252 for UE-N unicast, and functions at the UE of ROHC 423 and security 426. RBs 482 are handled in PDCP layer 402. The ROO layer 403 includes both segmentation and ARC function at base Station of segmentation and ARO 431 for UE-1 multicast, segmentation and ARQ 432 for UE-1 unicast, segmentation and ARQ 433 for UE-N multicast, segmentation and ARQ 434 for UE-N unicast, as well as UE functions of segmentation and ARQ 435 for the unicast channel of the UE, and segmentation and ARQ 436 for the multicast channel. RLC channels 483 are handled in RLC layer 403. MAC layer 404 includes functions of scheduling and priority handling 441 at the base station, multiplexing 443 and HARQ 446 for UE-1 at the base station, multiplexing 444 and HARQ 447 for UE-N at the base station; and functions for the UE of scheduling and priority handling 442 of the UE, multiplexing 445 of the UE and HARQ 448 of the UE. Logic channels 484 and transport channels 485 are handled at MAC layer 404.

In one novel aspect, a PUCE status report is initiated by the UE upon detecting SN gap in the PDCP SDU reception buffer for a period of time. The PDCP status report is not triggered by network command or network configuration. The UE initiates the PUCE status report procedure based on UE local conditions. In one embodiment, the period of time is controlled by a t-reordering timer at the UE. The UE monitors the received SN for the PUCE SDU. Upon detecting the SN gap in the reception buffer, the UE performs a UE initiates PDCP status report procedure. A UK-initiated PUCE status report is generated upon detecting one or more predefined conditions. The UE compiles the PDCP status report and sends to the wireless network. The following diagrams illustrates conditions and operations for the UE-initiated PDCP status report procedure.

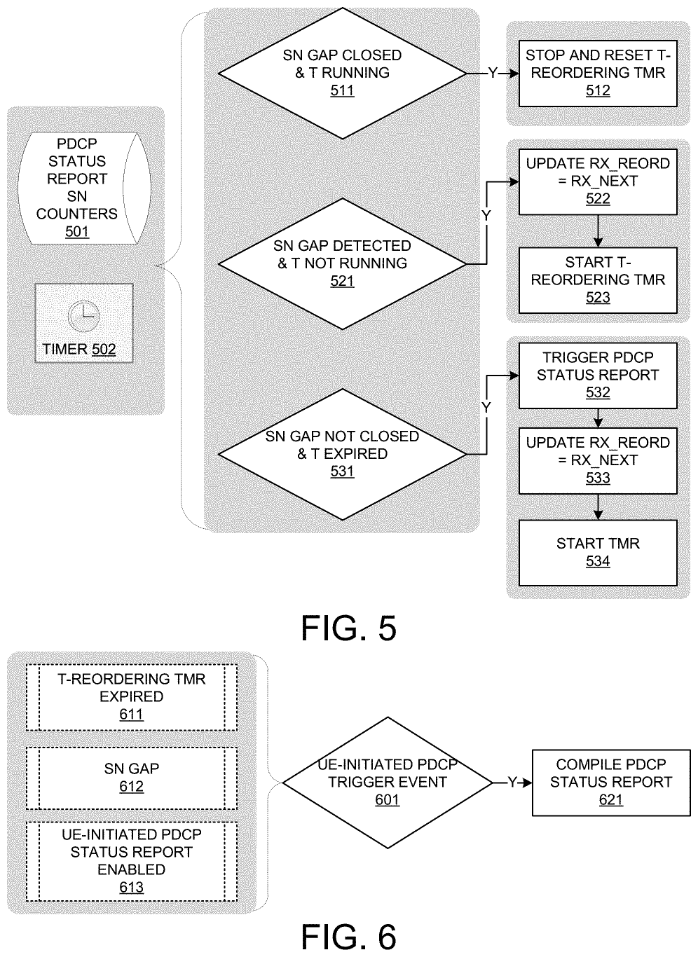

FIG. 5 illustrates exemplary diagrams for the conditions and procedures for the UE-initiated. POCP status report. In one novel aspect, the UE initiates a PDCP status report procedure and send a PDCP status report to the network. In one embodiment, the UF uses a t-reordering timer 502 to determine whether to trigger the POCP status report. In another embodiment, the UE further monitors a set of SN parameters 501. In one embodiment, the UE set a count value RX_DELIV to the COUNT value of the first PDCP SDU which has not been delivered to upper layers. The Count value for the latest received PDCP SDU RCVD_COUNT=[RCVD_HFN, RCVD_SN].When each PDCP PDU is received, UE takes a series of actions to determine whether to store the PDCP SDU in the reception buffer. A count value RX_NEXT is set be a count value of a next PDCP SDU expected to be received. UE updates RX_NEXT to RCVD_COUNT+1. An SN gap is detected when the RX_NEXT is greater than the RX_DELIV. A reorder count value RX_REORD is set to be RX_NEXT upon detecting the SN gap and RX_REORD is updated when more packets are received. The UE performs PDCP status report based on the count values, including RX_DELIV, RX_NEXT and RX_REORD. If PDCP SDU is stored in the reception buffer, PDCP re-orderng and status report triggering is performed.

For condition 511, the UE determines if the SN_gap is closed, e.g., RX_DELIV>=RX_REORD, and t-Reordering timer is running. The SN gap is closed when the t-reordering timer is still running. It means that all SDUs that are received out of order have been successfully received. If condition 511 is true, at step 512, the UE stops and resets t-Reordering timer. For condition 521, the UE determines if a new SN_gap occurs, i.e., RX_DELIV<RX_NEXT, and t-reordering timer is not running. If condition 521 is true, at step 522, the UE updates RX_REORD to RX_NEXT and, at step 523, starts the t-Reordering timer. For condition 531, the NE determines whether the existing SN gap is not closed, and t-Reordering expires. If condition 531 is true, it indicates that the UE-initiated RDCP status report needs to be sent. At step 532, the UE triggers STATUS report, updates RX_REORD to RX_NEXT at step 533, and starts the t-reordering timer at step 534. In one embodiment, when t-Reordering expires, UE delivers the PDCP SDUs to the upper layers. The UE delivers to upper layers in ascending order of the associated count value after performing header decompression if not decompressed before. All stored PDCP SDI (s) with consecutively associated SN count value(s) starting from Count value RX_DELIV are delivered to the upper layer. The NE updates RX_DELIV to the count value of the first PDGF SDU which has not been delivered to upper layers with count value>RX_DELIV.

FIG. 6 illustrates exemplary diagrams of conditions for the PDCP status reports. In one novel aspect, the UE initiates a PDCP status report based on one or more predefined triggering events. The PDCP status report triggers PDCP-based retransmission. At step 601, the NE monitors one or more predefined trigger events. The trigger events is one or more predefined/preconfigured events including the t-reordering timer expiration 611, a detected SN gap 612, and a UE capability with the UE-initiated PDCD status report enabled 613. If a PDCP status report is triggered by one or more of the predefined triggering events, the UE, at step 621, compiles a PDCP status report. The PDCP status report is sent to the network to trigger a PDC retransmission.

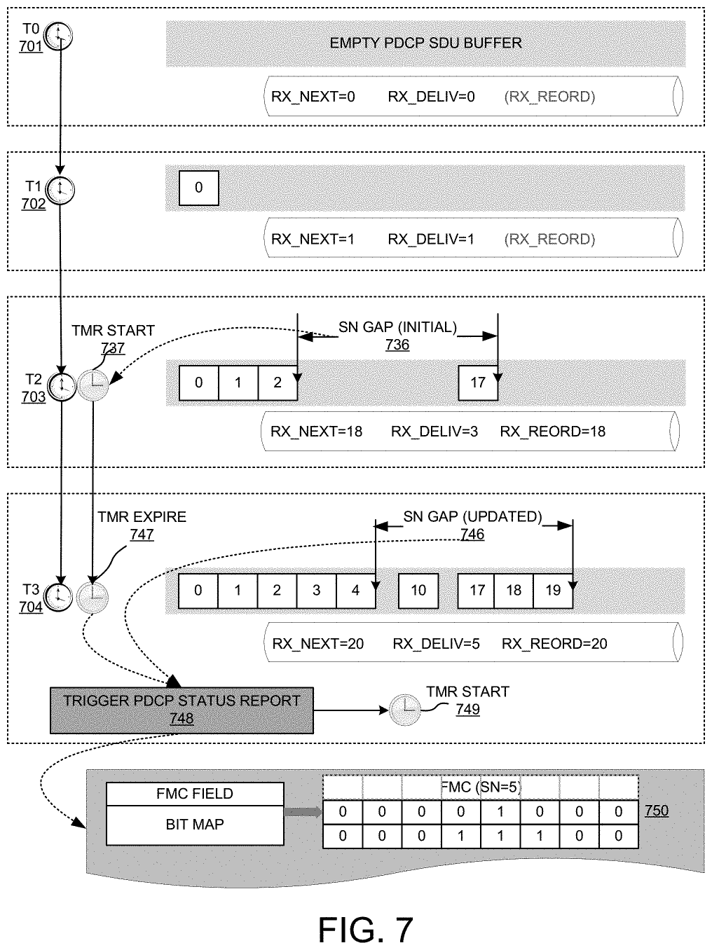

FIG. 7 illustrates exemplary diagrams for an exemplary process to update the state variables and trigger a PDCP status report under the control of t-Reordering. In the initial state T0 701, no SDU is received with empty PDCP SDU buffer. The initial values of RX_NEXT=0 and RX_DELIV=0. In T1 state 702, when SDU with COUNT=0 is received, RX_NEXT and RX_DELIV are updated to RX_NEXt=1 and RX_DELIV=1. In both states 701 and 702, timer t-Reordering is not triggered because there is no missing PDC? SDU, so RX_REORD is not initialized. In another embodiment, the RX_REORD is set to a non-initialized value. In T2 state 703, SDUs with Count=0, 1, 2, have been received, and then SDUs with Count=17 is received. Since SDUs must be delivered to the upper layer in order, the first count value of SDU which is not delivered to the upper layers is “3”. The UE updates RX_DELIV=3, and RX_NEXT=18. At T2 703, the UE detects the initial SN gap 736 when RX_DELIV<RX_NEXT. The RX_REORD is updated to the count value following the count value associated with the current PDCP SDU, which is RX_NEXT=18. The UE detects the triggering event conditions of the SN gap exist and there is no t-reordering timer running. At step 737, the t-Reordering timer is started between T2 703 and T3 704 states, the t-Reordering timer is in running, and SDUs with COUNT=3,4,10,18,19, are received. During this period, UE only delivers the PDCP SOUS in ascending order of the associated COUNT value consecutively and updates RX_DELIV=5. RX_REORD is updated to RX_NEXT=20. In T3 state 704, the t-Reordering timer expires. The update SN_gap 746, with RX_DELIV=5 and RX_REORD=20 is not closed, so according to condition 531 of FIG. 5, a PDCP STATUS report is triggered at step 748. At step 749, the t-Reordering is restarted. Not shown in the example here, before the t-reordering timer expires, the SN GAP is closed, with the RX_DELIV equals RX_REORD, the t-reordering is stopped.

In one embodiment, the PDCP status report includes information of an updated SN gap generated in one embodiment 750, the updated SN gap information includes a first missing count (FMC) and a bitmap. As an example, the FMC for T3 state 704 is “5”. The bitmap is allocated with a length in bits equals to the number of COUNTs from and not including the first missing PDCP SDU up to and including the last out-of sequence PDCP SDUs, rounded up to multiple of “8”; or up to and including a PDCP SDU for which the resulting PDCP control POU size is equal to 9000 bytes, whichever comes first. The UE sets in the bitmap field as ‘0’ for all PDCP SDUs that have not been received, and optionally PDCP SDUs for which decompression have failed. The UE sets in the bitmap field as ‘1’ for all PDCP SDUs that have been received. As an example, with FMC=5, the first bit of the bitmap starts for count=6. SDUs with count=6, 7, 8, 9, 11, 12, 13, 14, 15, 16, are missing, with the corresponding bits in the bitmap set to be “0”. SDUs with count=10, 17, 18, 19, are correctly received with the corresponding bits in the bitmap set to be “1”. Padding are inserted when needed to round up the bitmap to be multiple of “8”.

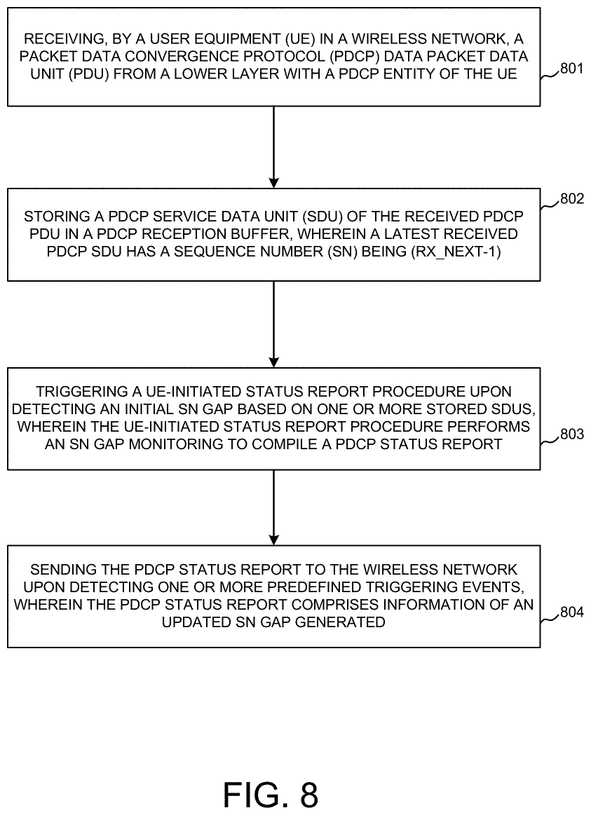

FIG. 8 illustrates an exemplary flow chart for the UE-initiated PDCP status report procedure. At step 801, the UE receives a PDCP PDU from a lower layer with a PDCP entity of the UE. At step 802, the UE stores a PDCP service data unit (SDU) corresponding to the received PDCP PDU in a PDCP reception buffer. At step 803, the UE triggers a UE-initiated status report procedure upon detecting an initial SN gap based on one or more stored SDUs, wherein the UE-initiated status report procedure performs an SN gap monitoring to compile a PDCP status report. At step 804, the UE sends the PDCP status report to the wireless network upon detecting one or more predefined triggering events, wherein the PDCP status report comprises information of an updated SN gap generated.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the clams.

What is claimed is:

1. A method comprising:
receiving, by a user equipment (UE) in a wireless network, a packet data convergence protocol (PDCP) packet data unit (PDU) from a lower layer with a PDCP entity of the UE;
storing a PDCP service data unit (SDU) corresponding to the received PDCP PDU in a PDCP reception buffer;
triggering a UE-initiated status report procedure upon detecting an initial SN gap based on one or more stored PDCP SDUs, wherein the UE-initiated status report procedure performs an SN gap monitoring to compile a PDCP status report; and
sending the PDCP status report to the wireless network upon detecting one or more predefined triggering events, wherein the PDCP status report comprises information of an updated SN gap generated.

2. The method of claim 1, wherein the received PDCP PDU is a multicast data packet for a multicast broadcast service (MBS) received from a multicast radio bearer (MRB).

3. The method of claim 2, wherein the MRB is associated with a multicast channel to receive MBS data packets and a unicast channel to send feedback and to receive data retransmission, and wherein the PDCP status report is sent to the wireless network through the associated unicast channel.

4. The method of claim 1, wherein stored PDCR SDUs with consecutive SNs are delivered to upper layers with a delivered count value RX_DELIV set to be a count value of a first PDCP SDU which has not been delivered to upper layer, and wherein the initial SN gap is detected upon RX_NEXT is greater than RX_DELIV.

5. The method of claim 4, wherein a reorder countevalue RX_REORD is set to be RX_NEXT upon detecting the initial SN gap.

6. The method of claim 4, wherein a reorder counte value RX_REORD is set to be RX_NEXT upon sending the PDCP status report.

7. The method of claim 4, wherein the UE detects SN gap being closed upon detecting RX_DELIV equals to RX_NEXT, and wherein a reorder count value RX_REORD is reset.

8. The method of claim 1, wherein the UE-initiated status report procedure starts a t-reordering timer upon detecting the initial SN gap when there is no t-reordering timer running.

9. The method of claim 8, wherein the one or more predefined triggering events include an expiration of the t-reordering timer.

10. The method of claim 8, wherein the UE detects SN gap being closed and stops the t-reordering timer.

11. The method of claim 1, wherein the updated SN gap is based on a count value of a first PDCP SDU which has not been delivered to upper layer and RX_NEXT, and wherein PDCP status report further comprises a bitmap of reception status of PDCP SDU between a latest consecutive PDCP SDU delivered and the RX_NEXT.

12. A user equipment (UE), comprising:
a transceiver that transmits and receives radio frequency (RF) signal in a wireless network;
a packet data convergence protocol (PDCP) entity that receives a PDCP packet data unit (PDU) from a lower layer;
a PDCP control module that stores a PDCP service data unit (SDU) corresponding to the received PDCP PDU in a PDCP reception buffer;
a PDCP status report control module that triggers a UE-initiated status report procedure upon detecting an initial SN gap based on one or more stored PDCP SDUs, wherein the UE-initiated status report procedure performs an SN gap monitoring to compile a PDCP status report; and
a PDCP status report sender that sends the PDCP status report to the wireless network upon detecting one or more predefined triggering events, wherein the PDCP status report comprises information of an updated SN gap generated.

13. The UE of claim 12, wherein stored PDCP SDUs with consecutive SNs are delivered to upper layers with a delivered count value RX_DELIV set to be a count value of a first PDOP SDU which has not been delivered to upper layer, and wherein the initial SN gap is detected upon RX_NEXT is greater than RX_DELIV.

14. The UE of claim 13, wherein a reorder countevalue RX_REORD is set to be RX_NEXT upon detecting the initial SN gap.

15. The UE of claim 13, wherein a reorder counte value RX_REORD is set to be RX_NEXT upon sending the PDCP status report.

16. The UE of claim 13, wherein the UE detects SN gap being closed upon detecting RX_DELIV equals to RX_NEXT, and wherein a reorder count value RX_REORD is reset.

17. The UE of claim 12, wherein the UE-initiated status report procedure starts a t-reordering timer upon detecting the initial SN gap when there is no t-reordering timer running.

18. The UE of claim 17, wherein the one or more predefined triggering events include an expiration of the t-reordering timer.

19. The UE of claim 17, wherein the UE detects SN gap being closed and stops the t-reordering timer.

20. The UE of claim 12, wherein the updated. SN gap is based on a count value of a first PDCP SDU which has not been delivered to upper layer and RX_NEXT, and wherein PDCP status report further comprises a bitmap of reception status of PDCP SDU between a latest consecutive PDCP SDU delivered and the RX_NEXT.
